(19) United States
(12) Patent Application Publication
(10) Pub. No.: US 2009/0118454 A1
(43) Pub. Date: May 7, 2009

(54) Nanocomposite Organolithic Macromolecular Material with Long-Range Structural Order

(76) Inventors: Pradyot A. Agaskar, Blacksburg, VA (US); Brian E. Hanson, Blacksburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 12/266,109

(22) Filed: Nov. 6, 2008

Related U.S. Application Data
(60) Provisional application No. 60/985,731, filed on Nov. 6, 2007.

(51) Int. Cl. C08G 77/14; C08G 77/20; C08G 77/08

(52) U.S. Cl. 528/24; 528/32

(57) ABSTRACT

The present invention relates to compositions of matter comprising polyhedral structural units of empirical formula Si₂O₃, with silicon atoms at the vertices of the polyhedron and oxygen atoms at the center of each edge, arranged in an ordered manner with a repeat distance characteristic of such order in the range of 1 to 2 nanometers and organosilicon crosslinking groups tying these units together to form a polymeric material that exhibits Bragg reflection peaks in the X-ray region of the electromagnetic spectrum. The present invention further relates to methods of preparing such compositions. The nanocomposite materials according to the invention may be useful, for example, as electronics packaging materials, as resists for e-beam lithography, as protective coatings, as binders for refractory sands, as the matrix in polymer matrix composites and as reflective materials in soft X-ray telescopes and microscopes.

### CROSS-REFERENCE TO RELATED APPLICATIONS

This application relies on the disclosure and claims the benefit of the filing date of U.S. Provisional Application No. 60/985,731, filed Nov. 6, 2007, the disclosure of which is incorporated herein by reference in its entirety.

### BACKGROUND OF THE INVENTION

1. Field of the Invention

The field of this invention relates to nanocomposite organolithic macromolecular materials (OMMs) with long-range structural order having a nanoscale characteristic repeat distance.

2. Description of Related Art

Organolithic Macromolecular Materials (OMMs) are composite materials consisting of an inorganic portion and an organic portion that have a definite chemical linkage between the two (A. D. Wilson & S. Crisp “Organolithic Macromolecular Materials” Applied Science Publishers Ltd. London, 1977, 3-4). A nanocomposite OMM is formed from nanoscale portions of inorganic and organic matter linked together to form a macroscopic polymeric material. The first such OMM where both portions were structurally well-defined was reported in 1989 (P. A. Agaskar, J. Am. Chem. Society 1989, 111, 6858-6859). Since that time a number of such materials have been prepared and their structural and macroscopic properties described in detail (C. Sanchez et al, Chem. Mater. 2001, 13, 3061-3083). Most recently a nanocomposite OMM was reported in 2002 (J. G. Matisons, J. Am. Chem. Society 1989, 124, 13998-13999) that was a clear elastomeric material.

The structural characteristic of these OMMs that distinguishes them from ordinary polymers is the medium range order, i.e. on the 1 to 2 nanometer scale the structure is well defined in terms of the atomic composition and the chemical linkages between the various atoms. However, none of these existing OMMs have any long range order, i.e. beyond about 2 nm, and the materials exhibit the characteristic amorphous diffraction pattern observed in all polymeric materials.

### SUMMARY OF THE INVENTION

One object of the present invention is to prepare a class of materials that includes nanocomposite OMMs comprising polyhedral structural elements linked together to form an extended 3-dimensional network polymer. A further object of the present invention is to have the cross-linking organosilicon moieties themselves forming a 3-connected network in which are embedded the polyhedral structural elements with definite chemical linkages between the two portions of the so formed nanocomposite material.

In addition, it has now also been unexpectedly found that by thermally treating a precursor compound in the presence of a polymerization initiator a nanocomposite OMM can be prepared that exhibits structural order beyond the medium range order characteristic of hitherto known nanocomposite OMMs. This long order manifests itself as several Bragg reflection peaks in the X-ray diffraction powder pattern.

The present invention includes a nanocomposite material of empirical formula CₐH_{b}O_{c}Si_{d}, wherein a=12 to 18; b=18 to 30; c=3 to 5; and d=4. Also included within the scope of the invention is nanocomposite material according to the empirical formula above, wherein up to half of the silicon atoms and less than all of the oxygen atoms form polyhedrons of empirical formula Si₂O₃, wherein the polyhedrons comprise the silicon atoms as polyhedron vertices and comprise the oxygen atoms as polyhedron edge centers. The invention also provides nanocomposite material according to the above specifications, wherein the polyhedrons are evidenced by silicon-29 magic angle spinning solid-state nuclear magnetic resonance spectrum.

The invention also includes nanocomposite material described above, wherein polyhedron structural elements of the nanocomposite material are arranged in a 3-dimensional pattern with long range structural order as evidenced by several strong Bragg reflection peaks in the X-ray region of the electromagnetic spectrum.

Nanocomposite material according to the invention further includes the above described nanocomposite material, wherein the long range structural order has a 1 to 2 nanometer repeat distance characteristic.

The invention includes methods of making a nanocomposite material according to the specifications described above comprising polymerizing a precursor compound having reactive functional groups covalently bound to the silicon vertices of the polyhedron. The methods according to the invention can also comprise heating the precursor compound to a temperature ranging from about 100 to about 200° C. Heating according to the methods of the invention can be carried out in the presence of ultraviolet radiation and/or in the presence of a free radical initiator, such as atmospheric oxygen.

Methods of making a nanocomposite material according to the above described specifications can comprise polymerizing a precursor compound having reactive functional groups covalently bound to the silicon vertices of the polyhedron. Such methods can further comprise heating the precursor compound to a temperature ranging from about 100 to about 200° C. Additionally, such methods according to the invention can comprise heating, which is carried out in the presence of ultraviolet radiation and/or in the presence of a free radical initiator, such as atmospheric oxygen.

### BRIEF DESCRIPTION OF THE DRAWINGS

FIG. 1 provides a schematic representation of an embodiment of the polymeric materials according to the invention, an exemplary nanocomposite OMM.

FIG. 2A is an FTNMR spectra (Silicon-29) of precursor compound of Example 1.

FIG. 2B is an FTNMR spectra (Carbon-13) of precursor compound of Example 1.

FIG. 3 provides a schematic representation of a molecular packing diagram of precursor compound as determined by single crystal x-ray diffraction measurements.

FIG. 4A is a CPMAS FTNMR spectra (Silicon-29) of the nanocomposite OMM prepared according to Example 2.

FIG. 4B is a CPMAS FTNMR spectra (Carbon-13) of the nanocomposite OMM prepared according to Example 2.

FIG. 5 provides an x-ray powder diffraction trace of the nanocomposite OMM prepared according to Example 2.

FIG. 6A is a CPMAS FTNMR spectra (Silicon-29) of the porous material prepared according to Example 3.

FIG. 6B is a CPMAS FTNMR spectra (Carbon-13) of the porous material prepared according to Example 3.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail. Thus, the following detailed description is not to be considered as limiting the invention to the embodiments described. Rather, the true scope of the invention is defined by the claims.

The invention comprises a composition of matter capable of being achieved in stages. For example, the first stage can include preparation of the polyhedral structural elements of empirical formula Si₂O₃ either in solution form or as a crystalline material. The next stage is achieved when these polyhedral structural elements, which may be discrete molecular entities or linked to each other to form beads-on-a-chain polymeric entities, are derivatized and reactive organosilicon functional groups attached by way of covalent bonds to the silicon atoms at the vertices. A third and typically final stage is reached when the so appended reactive organosilicon functional groups are induced to form linkages between themselves by the application of heat in the presence of an initiator which may be ionizing radiation, UV radiation or free-radical forming species such as molecular oxygen.

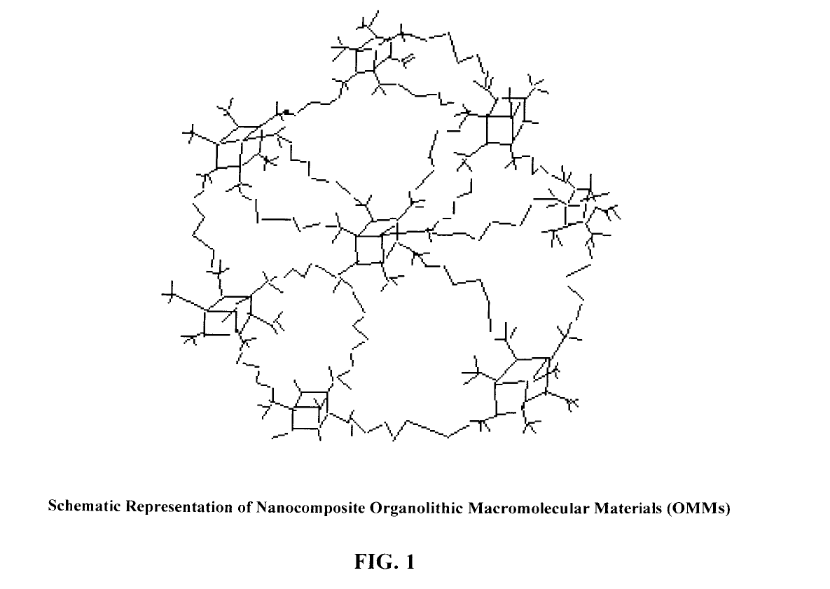

FIG. 1 provides a schematic representation of an embodiment of the polymeric materials according to the invention, an exemplary nanocomposite OMM. As shown in FIG. 1, the cubes are silica clusters which constitute the polyhedral structural elements described earlier, the 3-connected polymeric portion surrounds these polyhedral structural elements and is linked to them by way of covalent bonds, and the periodicity defined by the silica clusters is about 1 nm center-to-center.

The present invention includes nanocomposite materials of empirical formula CₐH_{b}O_{c}Si_{d}, wherein a=12 to 18; b=18 to 30; c=3 to 5; and d=4. In embodiments, the structure of the nanocomposite is such that up to half of the silicon atoms and less than all of the oxygen atoms of the nanocomposite together form polyhedrons of empirical formula Si₂O₃. In further embodiments, the structure of the polyhedrons is such that the silicon atoms comprise the vertices of the polyhedrons, thereby defining the edges of the polyhedron, and the oxygen atoms are at the centers of the polyhedron edges. In yet further embodiments, the polyhedral structural elements are arranged in a 3-dimensional pattern with long range structural order (as evidenced by the presence of several strong Bragg reflection peaks in the X-ray region of the electromagnetic spectrum). The repeat distance characteristic of the long range structural order can be between 1 and 2 nanometers.

As further explained in examples below, the nanocomposite materials can be formed from precursor compounds having the same empirical formula as the nanocomposite. The precursor may be polymerized by heating to a temperature anywhere within the range of from about 100° C. to about 200° C. For example, where the organosilicon functional groups comprise vinyl groups, polymerization can be observed at 180° C. and a solid resin of identical equivalent weight to the precursor can be obtained, i.e., with no loss of mass upon polymerization. If desired, polymerization can also be carried out in the presence of ultraviolet radiation and/or in the presence of a free radical initiator, such as atmospheric oxygen.

This nanocomposite OMM can be used in this final form in a variety of applications, for example, as the matrix material in a carbon fiber composite object or as a binder in silica sand molds used in casting metal objects. It can also be used as a resist material in the microelectronic fabrication industry and as an X-ray mirror. Chemical modifications of the nanocomposite OMM in its final form can lead to nanoporous materials that would display high ionic conductivities, a property of use in the fabrication of electrochemical devices such as batteries and ultracapacitors.

### Example 1

A solution of tetramethylammonium hydroxide in methanol was mixed with tetramethylorthosilicate in 1:1 molar ratio to yield a solution wherein substantially all the silicon atoms are included in discrete molecular ions of empirical formula [Si₈O₂₀]⁸⁻. These polyhedral structural elements were then allowed to react with an organosilicon compound such as ClSi(CHCH₂)₃ so as to form a solution of the precursor compound [Si₈O₁₂](OSi(CHCH₂)₃)₈ and tetramethylammonium chloride.

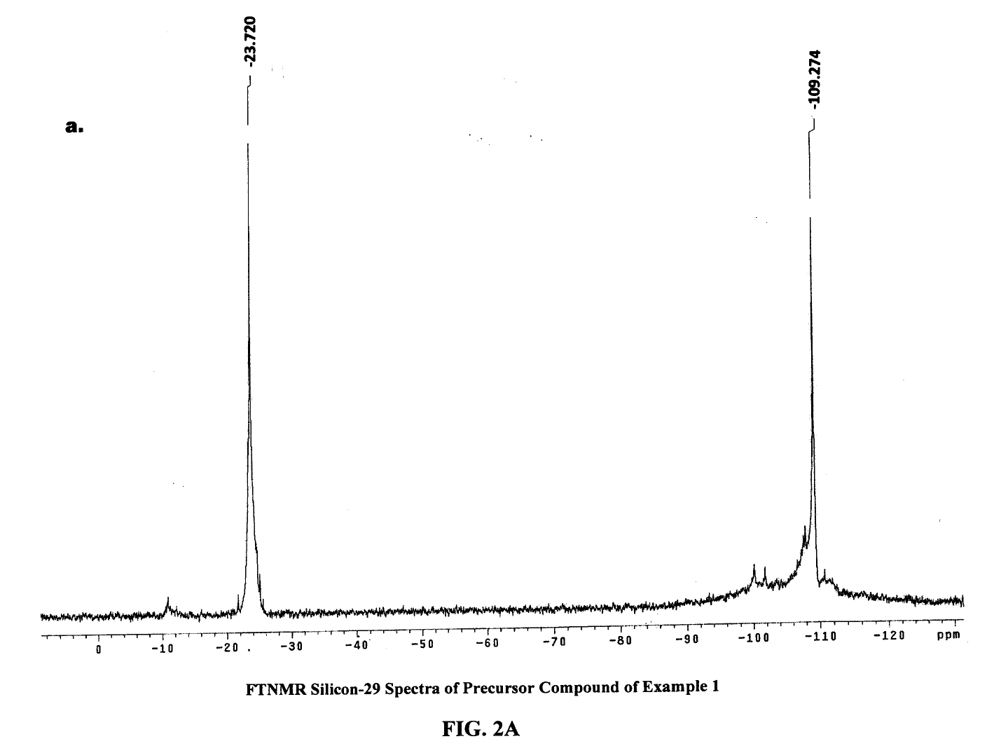

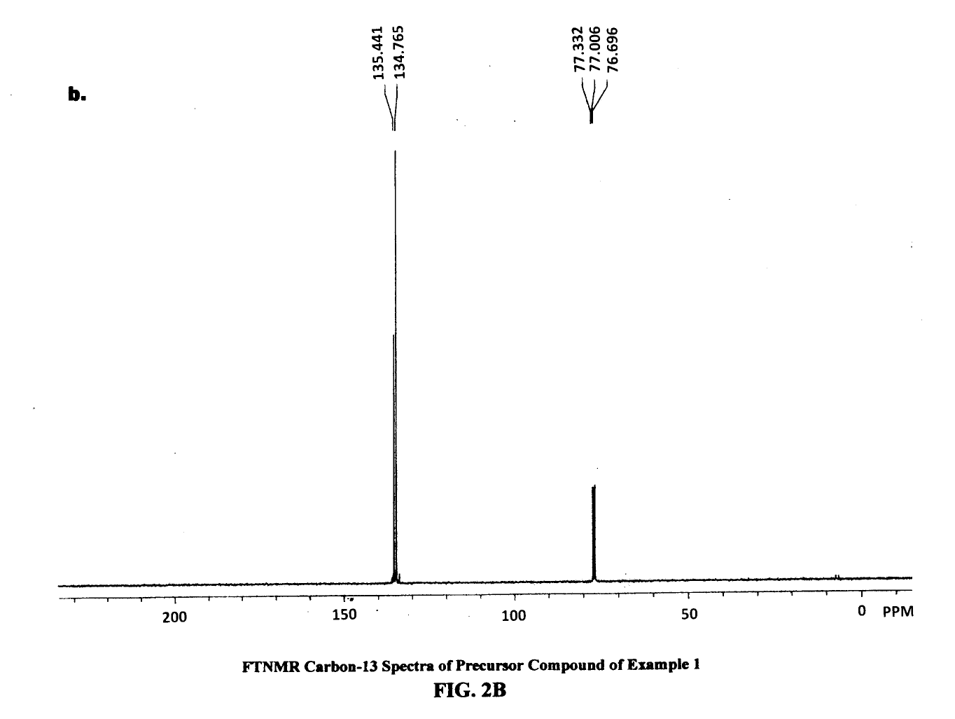

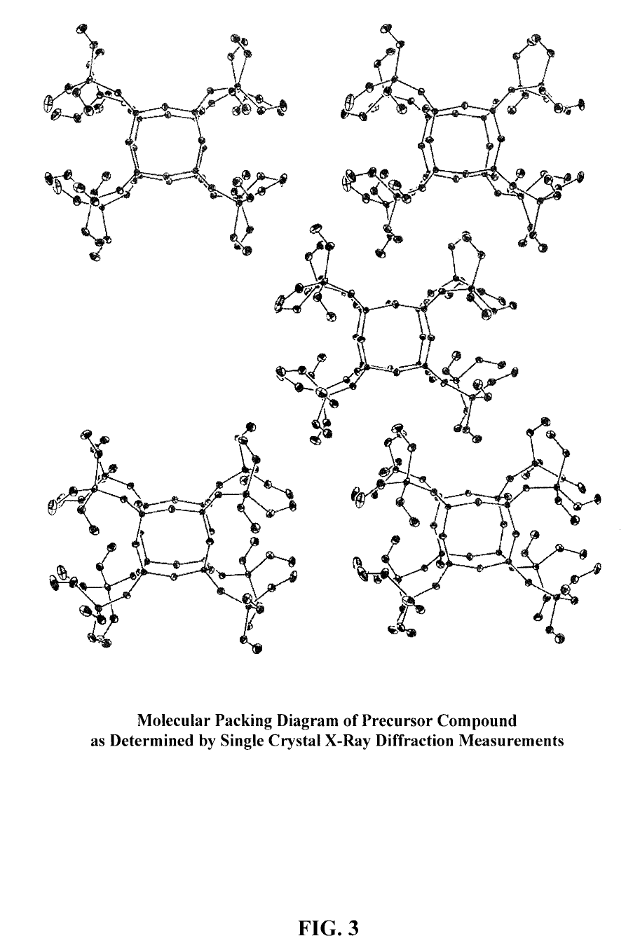

After extraction of the precursor compound into a hydrocarbon solvent phase such as n-pentane, a crystalline form of the precursor compound was obtained by removing the solvent. The FTNMR Spectra of the precursor compound prepared according to Example 1 is shown in FIGS. 2a (Silicon-29) and 2b (Carbon-13). The molecular packing diagram, as determined by single crystal X-ray diffraction measurements, of the precursor compound prepared according to Example 1 is shown in FIG. 3.

### Example 2

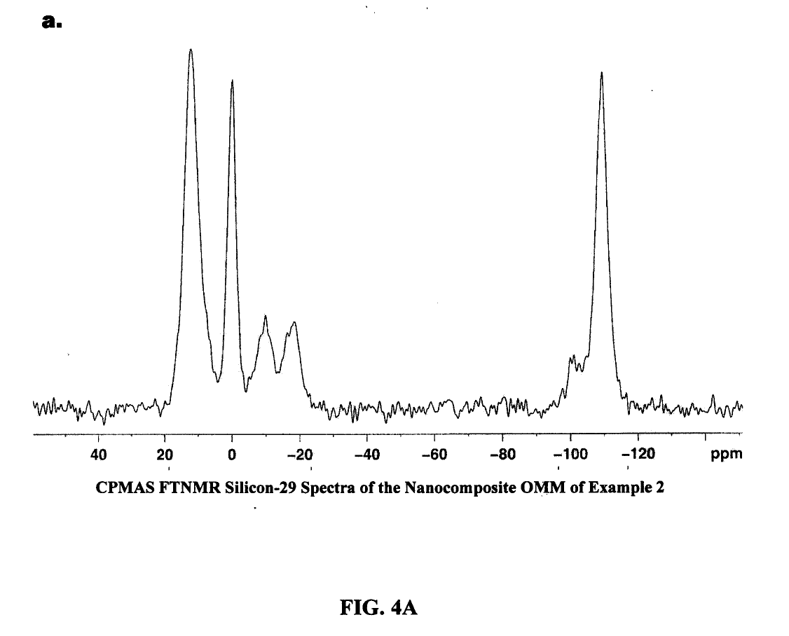

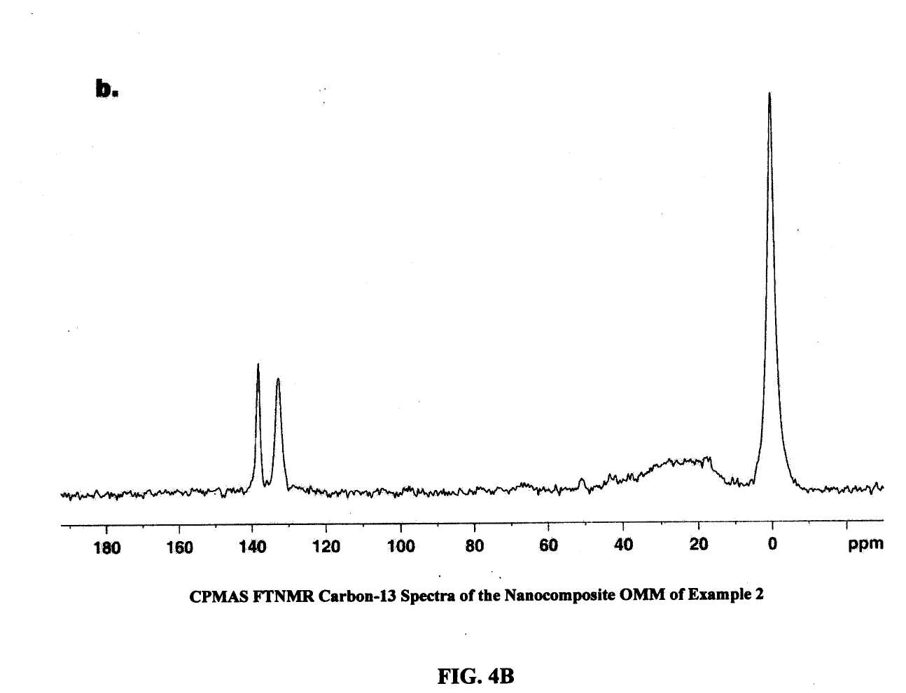

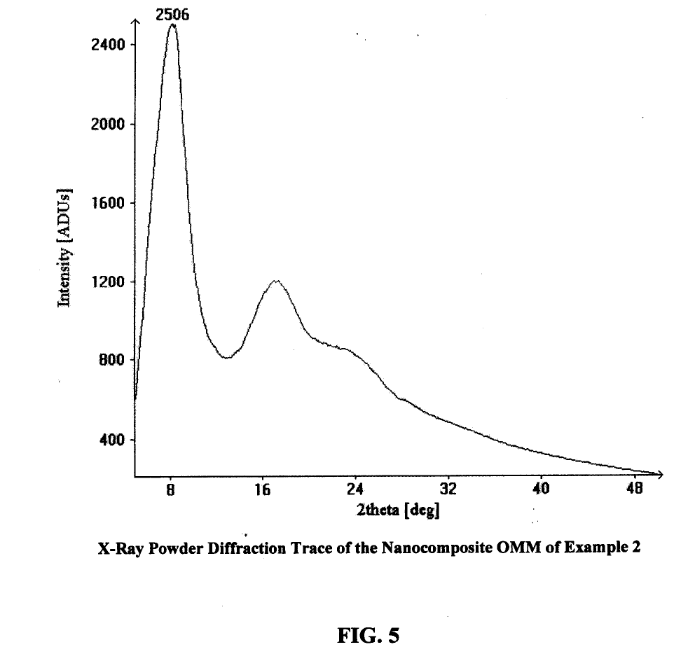

The precursor compound isolated as crystals as described in Example 1 was heated up to about 475 Kelvin (about 202° C.), whereupon having first melted at about 400 Kelvin (about 127° C.), it was converted into the nanocomposite OMM form and became a clear, hard solid. The CPMAS FTNMR spectra of the nanocomposite OMM prepared according to Example 2 are shown in FIGS. 4A (Silicon-29) and 4B (Carbon-13). The structural changes resulting from the heat treatment of the precursor are clearly reflected by the differences between these and the spectra shown in FIGS. 2A and 2B. As shown in FIG. 5, the X-ray powder diffraction trace of the nanocomposite OMM prepared according to Example 2, which shows the Bragg reflection peaks at about 8 and 16 2-theta, is indicative of long-range structural order.

### Example 3

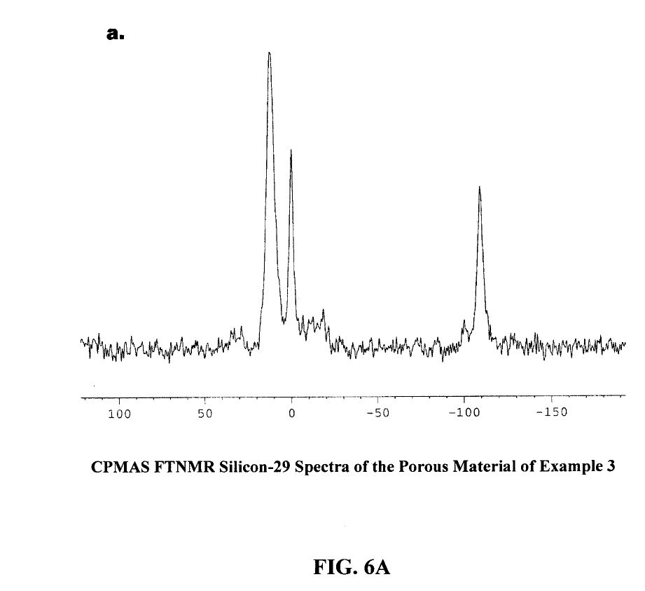

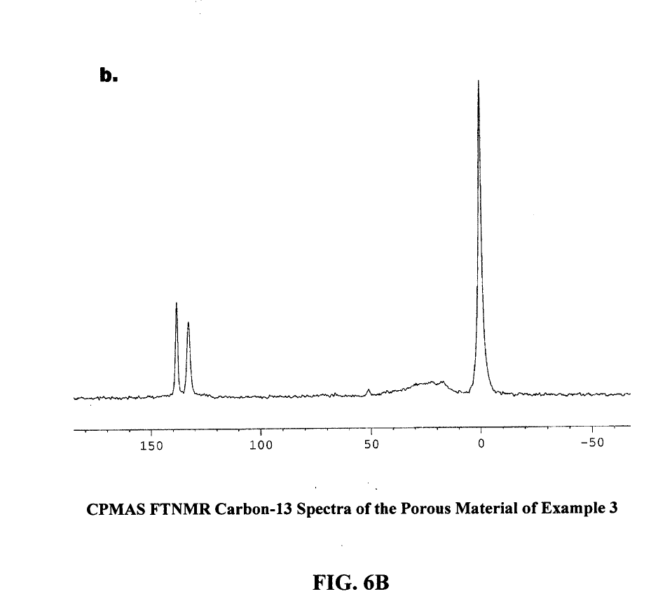

The nanocomposite OMM form of the material, prepared as described in Example 2, was treated with an aqueous solution of hydrofluoric acid over a period of two hours. After filtration the residue was washed with water and dried. The dry solid obtained weighed about 20% less than the amount of starting material, which is indicative of the loss of the polyhedral structural elements resulting in the formation of a porous material. The CPMAS FTNMR spectra of the porous material prepared according to Example 3 are shown in FIGS. 6A (Silicon-29) and 6B (Carbon-13). As shown in FIG. 6A, the peak due to the polyhedral structural units at −109 ppm is seen to be clearly diminished when compared to FIG. 4A. The surface area of the material prepared as described here was measured to be about 17 square meters per gram and the pore size distribution is in the range of about 1.4 to 2.9 nm.

The present invention has been described with reference to particular embodiments having various features. Upon consideration of the specification and appended claims, it will be apparent to one skilled in the art that these objects along with others not explicitly listed above are provided by the invention disclosed herein. In particular, it will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. A nanocomposite material of empirical formula CₐH_{b}O_{c}Si_{d},
wherein a=12 to 18; b=18 to 30; c=3 to 5; and d=4.

2. The nanocomposite material according to claim 1, wherein up to half of said silicon atoms and less than all of said oxygen atoms form polyhedrons of empirical formula Si₂O₃, wherein said polyhedrons comprise said silicon atoms as polyhedron vertices and comprise said oxygen atoms as polyhedron edge centers.

3. The nanocomposite material according to claim 2, wherein said polyhedrons are evidenced by silicon-29 magic angle spinning solid-state nuclear magnetic resonance spectrum.

4. The nanocomposite material according to claim 1, wherein polyhedron structural elements of said nanocomposite material are arranged in a 3-dimensional pattern with long range structural order as evidenced by several strong Bragg reflection peaks in the X-ray region of the electromagnetic spectrum.

5. The nanocomposite material according to claim 2, wherein polyhedron structural elements of said nanocomposite material are arranged in a 3-dimensional pattern with long range structural order as evidenced by several strong Bragg reflection peaks in the X-ray region of the electromagnetic spectrum.

6. The nanocomposite material according to claim 3, wherein polyhedron structural elements of said nanocomposite material are arranged in a 3-dimensional pattern with long range structural order as evidenced by several strong Bragg reflection peaks in the X-ray region of the electromagnetic spectrum.

7. The nanocomposite material according to claim 4, wherein said long range structural order has a 1 to 2 nanometer repeat distance characteristic.

8. The nanocomposite material according to claim 5, wherein said long range structural order has a 1 to 2 nanometer repeat distance characteristic.

9. The nanocomposite material according to claim 6, wherein said long range structural order has a 1 to 2 nanometer repeat distance characteristic.

10. A method of making a nanocomposite material according to claim 1 comprising polymerizing a precursor compound having reactive functional groups covalently bound to said silicon vertices of said polyhedron.

11. The method according to claim 10, comprising heating said precursor compound to a temperature ranging from about 100 to about 200° C.

12. The method according to claim 11, wherein said heating is carried out in the presence of ultraviolet radiation.

13. The method according to claim 11, wherein said heating is carried out in the presence of a free radical initiator.

14. The method according to claim 13, wherein said free radical initiator is atmospheric oxygen.

15. A method of making a nanocomposite material according to claim 2 comprising polymerizing a precursor compound having reactive functional groups covalently bound to said silicon vertices of said polyhedron.

16. The method according to claim 15, comprising heating said precursor compound to a temperature ranging from about 100 to about 200° C.

17. The method according to claim 16, wherein said heating is carried out in the presence of ultraviolet radiation.

18. The method according to claim 16, wherein said heating is carried out in the presence of a free radical initiator.

19. The method according to claim 18, wherein said free radical initiator is atmospheric oxygen.
